(19) United States
(12) Patent Application Publication
(10) Pub. No.: US 2024/0082775 A1
(43) Pub. Date: Mar. 14, 2024

(54) HIGH DENSITY FILTER ELEMENT

(71) Applicant: Cummins Filtration Inc., Nashville, TN (US)

(72) Inventors: Dhananjay Kumar Singh, Pune (IN); Shantanu Sanjay Ghatnekar, Pune (IN); Balasaheb Mahadev Bhittam, Kolhapur (IN)

(73) Assignee: Cummins Filtration Inc., Nashville, TN (US)

(21) Appl. No.: 18/516,355

(22) Filed: Nov. 21, 2023

Related U.S. Application Data
(63) Continuation of application No. PCT/US2022/030048, filed on May 19, 2022.

(30) Foreign Application Priority Data
May 26, 2021 (IN) 202141023410

(51) Int. Cl. B01D 46/52; B01D 29/01; B01D 35/00; B01D 46/54; B01D 63/06

(52) U.S. Cl. CPC B01D 46/527; B01D 29/016; B01D 35/005; B01D 46/546; B01D 63/067; B01D 2201/12; B01D 2279/60

(57) ABSTRACT

A media pack includes a filtration sheet and a support sheet engaged with the filtration sheet. The support sheet includes a first perforated sheet and a first media sheet, the first perforated sheet and the first media sheet being corrugated. The filtration sheet and the support sheet are wound together in a substantially spiral shape. The filtration sheet and the support sheet together form a plurality of channels that are alternatively sealed on opposing ends of the media pack.

### CROSS-REFERENCE TO RELATED PATENT APPLICATIONS

The present application is a continuation of PCT Application No. PCT/US2022/030048, filed May 19, 2022 which claims the benefit of and priority to Indian Provisional Patent Application No. 202141023410, filed May 26, 2021. The contents of these applications are incorporated by reference in their entireties.

### TECHNICAL FIELD

The present disclosure relates generally to filters for use with internal combustion engine systems.

### BACKGROUND

Internal combustion engines generally use various fluids during operation. For example, fuel (e.g., diesel, gasoline, natural gas, etc.) is used to run the engine. Air may be mixed with the fuel to produce an air-fuel mixture, which is then used by the engine to run under stoichiometric or lean conditions. Furthermore, one or more lubricants may be provided to the engine to lubricate various parts of the engine (e.g., piston cylinder, crank shaft, bearings, gears, valves, cams, etc.). These fluids may become contaminated with particulate matter (e.g., carbon, dust, metal particles, etc.) which may damage the various parts of the engine if not removed from the fluid. To remove such particulate matter and/or other contaminants, the fluid is generally passed through a filter assembly (e.g., a fuel filter, a lubricant filter, an air filter, a water filter assembly, etc.) structured to clean the fluid. The particulate matter holding capacity of a filter assembly (e.g., the amount of dust loading that can be accommodated by the filter assembly before the filter assembly must be replaced), and thus the overall life of a filter element within the filter assembly, may be limited in part by the size of the filter assembly. The filter assembly also restricts the fluid flow and may become damaged if the pressure drop across the filter assembly increases above certain threshold levels.

### SUMMARY

One embodiment of the present disclosure relates to a media pack including a filtration sheet and a support sheet engaged with the filtration sheet. The support sheet includes a first perforated sheet and a first media sheet. The first perforated sheet and the first media sheet are corrugated. The filtration sheet and the support sheet are wound together in a substantially spiral shape and form a plurality of channels. The channels are alternatively sealed on opposing ends of the media pack.

Another embodiment of the present disclosure relates to a media pack including a first support sheet, a second support sheet, and a media sheet. The first support sheet and the second support sheet each include a plurality of openings extending along a central axis of the media pack. The media sheet is disposed between and engaged with the first support sheet and the second support sheet.

Yet another embodiment of the present disclosure relates to a support sheet for a media pack. The support sheet includes a plurality of extending members, a first end connector, and a second end connector. The plurality of extending members are spaced apart from one another to define a plurality of axially extending channels. The first end connector is coupled to a first end of the plurality of extending members and extends substantially perpendicular to the plurality of extending members. The first end connector is offset from a central axis of at least one of the plurality of extending members. The second end connector extends substantially parallel to the first end connector and is coupled to a second end of the plurality of extending members opposite the first end.

At least one embodiment relates to an axial flow filter element including alternatively-sealed channels formed by layers of uncorrugated (e.g., flat) filtration sheets separated by corrugated support sheets that include a perforated structural support layer. The perforated layer improves the structural integrity of the filter element against high differential pressures in high flow rate applications. The structure of the support layer improves the strength of the filter element without requiring bonding or adhesive products to attach the support sheet to the filtration sheet.

In one set of embodiments, a media pack includes a filtration sheet and a support sheet. The support sheet is engaged with the filtration sheet and includes a first perforated sheet and a first media sheet, the first perforated sheet and the first media sheet being corrugated. The filtration sheet and the support sheet are wound together in a substantially spiral shape and form a plurality of channels. The channels are alternatively sealed on opposing ends of the media pack.

In another set of embodiments, a media pack includes a first support sheet, a second support sheet, and a media sheet. The first support sheet and the second support sheet each includes a plurality of openings extending along a central axis of the media pack. The media sheet is disposed between and engaged with the first support sheet and the second support sheet.

In some embodiments, a first end of the media sheet is bonded to the first support sheet and a second end of the media sheet opposite the first end is bonded to the second support sheet. In other embodiments, the media sheet is wrapped around at least one end of the first support sheet such that the media sheet covers three sides of the first support sheet.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing in this disclosure are contemplated as being part of the subject matter disclosed herein.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a top view of a filter element, according to an embodiment.

FIG. 2 is a top perspective view of a media pack for the filter element of FIG. 1.

FIG. 3 is a top perspective view of a portion of the media pack of FIG. 2, according to an embodiment.

FIG. 4 is a top perspective view of an axial end portion of the media pack of FIG. 2.

FIG. 5 is a perspective view of an unwound media pack for a filter element, according to an embodiment.

FIG. 6 is a perspective view of a filter element, according to another embodiment.

FIG. 7 is a top view of the filter element of FIG. 6.

FIG. 8 is a front view of a media form for the filter element of FIG. 6, according to an embodiment.

FIG. 9 is a front view of a support sheet of the media form of FIG. 8.

FIG. 10 is a front view of a support sheet of a media form, according to another embodiment.

FIG. 11 is a perspective view of an unwrapped portion of a media form for a filter element, according to another embodiment.

FIG. 12 is a side cross-sectional view of a media pack made from the media form of FIG. 11.

FIG. 13 is a perspective view of the media form of FIG. 11 in a first stage of assembly, according to an embodiment.

FIG. 14 is a perspective view of the media form of FIG. 11 in a second stage of assembly, according to an embodiment.

FIG. 15 is a side cross-sectional view of the media form of FIG. 11.

FIG. 16 is another side cross-sectional view of the media pack made from the media form of FIG. 11.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to filter assemblies including axial flow (e.g., channel flow, wall flow, etc.) filter elements. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

Filter assemblies are used in internal combustion engine systems to remove particulate contamination from a working fluid (e.g., air, lube oil, fuel, etc.). Among other factors, filter performance (e.g., pressure drop, contaminant removal efficiency, service life, etc.) is a function of the filter media properties of the filter assembly, the arrangement of filter media, and the operating parameters of the fluid system. In particular, filter performance is a function the total filter media surface area available for filtration. In general, increasing the media surface area for a given flow rate of fluid improves filter performance (e.g., reduces face velocity and pressure drop across the media, and increases the particulate holding capacity of the filter assembly). Filtration assemblies with large media surface areas are especially desirable in oil/lube filtration for high pressure hydraulic systems and fuel filtration for engine common rail systems, where high particle removal efficiencies at small particle sizes are required. However, the total amount of media that can be accommodated within a filter assembly is often limited by application specific constraints.

One way of increasing the media surface area within a filter assembly is to modify the geometry of the media. For example, the media may be corrugated (e.g., pleated, folded, etc.) or otherwise formed to provide a greater media surface area across a fixed volume. The flow may be oriented normal to the filter media surface (in a “normal flow filter element”), substantially parallel to the media surface (e.g., along axial channels formed between the corrugations or in multiple directions along the media surface), and/or along components of each. Normal flow filter elements are commonly used in diesel fuel, hydraulic, lube and many air intake applications. In such applications, it is important that the corrugations in the media retain their shape under the applied pressure drop from the working fluid. For this reason, normal flow filter elements often include screens and/or stronger, thicker media.

Axial flow filter elements, which include, for example, parallel or channel flow filter elements, are often found in air, diesel emission control, and membrane filtration applications. In some an axial flow filter elements, channels that extend along an entire axial length of the filter media block are created by stacking or otherwise layering sheets of corrugated media and then alternately sealing the upstream and downstream ends of each channel. An impermeable spacer layer (impermeable to the fluid to be filtered) is then positioned between the filter media layers to separate the clean and dirty sides of each layer. The channels of the filter element of filter media may be alternately sealed at the upstream and downstream ends using an adhesive product such as hotmelt or glue. Fluid entering each channel passes along the length of the channel, through one layer of filter media, away from the impermeable spacer layer and out through the unsealed end of an adjacent channel (having an unsealed downstream end). In this implementation, each layer of media on either side of the spacer may provide a filtration function. In other embodiments, an axial flow filter element may include open regions where the flow may move in a transverse and/or tangential direction through the media pack instead of only along channels.

Among other benefits, the layering of filter media in an axial flow filter element provides a significant increase in the overall media surface area as compared to a normal flow filter element for the same package space (e.g., volume). However, axial flow filter elements may not provide adequate structural integrity in high pressure liquid filtration applications, as the pressure drop encountered in these applications is sufficient to collapse the channels formed by the filter media. Additionally, the impermeable spacer layer directs the fluid flow in a single direction through the filter media layers (e.g., radially inward). This pressure differential accumulates across the layers, resulting in a large net radial force acting towards the center of the filter element. The situation is worsened when high contaminant removal efficiencies are required, as the pressure drop across filter media tends to increase with increased removal efficiency. For these reasons, the minimum size of the filter element is limited to ensure that the pressure drop across the filter element remains below threshold values.

In contrast to the foregoing filter element designs, at least one implementation described herein relates to an axial flow filter element including alternatively-sealed channels formed by layers of uncorrugated (e.g., flat) filtration sheets separated by corrugated (e.g., pleated, folded, etc.) support sheets that include a perforated structural support layer. Like the filtration sheets, the support sheets are made from filter media, which allows the flow to pass in multiple directions (e.g., both substantially radially inwards and substantially radially outwards from the dirty to the clean side of the media pack). This alternating flow configuration of each layer balances the pressure differential between adjacent layers, rather than allowing the differential pressure to accumulate radially towards the center of the filter element.

In at least one embodiment, the support sheet includes a perforated sheet and a media sheet (e.g., layer, etc.) that are both corrugated. For example, the media sheet may be placed on top of the perforated sheet to form a layered sheet that is corrugated (e.g., pleated, etc.) or otherwise formed into the desired shape. Among other benefits, the layering of a perforated sheet with the media sheet allows a thinner media to be used (due to the added support provided by the perforated sheet) to achieve the desired pressure drop across the filter element without sacrificing the structural integrity of the filter element. The perforated sheet also eliminates the need to bond adjacent media sheets together, which would otherwise be required to maintain the shape of a corrugated media sheet. In some embodiments, the filtration sheet may also include a perforated sheet (e.g., a second perforated sheet) in addition to the filter media to further increase the structural stability of the filter element under fluid loading.

In at least one embodiment, the filter element includes a plurality of spacer sheets in between adjacent layers of the filtration sheet rather than a corrugated support sheet in between the adjacent filtration sheets. The spacer sheets may include openings (e.g., slots, etc.) that extend along the axis of the filter element. The openings act as axial channels to direct flow toward and away from the filter media. In at least one embodiment, a first end of the media sheet is bonded to the first spacer sheet, at a closed axial end of the first spacer sheet, and a second end of the media sheet is bonded to the second spacer sheet at a closed axial end of the second spacer sheet. Among other benefits, the spacer sheets separate adjacent layers of media sheets while at the same time guiding inlet and outlet flow through the media sheets. In other words, the volume occupied by the spacer sheets is utilized to direct the flow of fluid, rather than only to separate adjacent media sheets (or the dirty and clean sides of the media sheets).

In at least one embodiment, the media sheet is wrapped around at least one end of the first spacer sheet such that the media covers three sides of the first spacer sheet. Among other benefits, this structure eliminates the need to apply adhesive product along both ends of the media sheet, and thereby reduces the risk of fluid bypass between the clean and dirty sides of the filter element.

In any of the above embodiments, the filtration sheet and the support sheet may be wound together in a substantially spiral shape to form the media pack.

The filter element includes a media pack and supporting elements (e.g., frame, endcaps, seals, etc.) that physically connect the media pack to the filter housing. The term “media pack” refers to a portion of the filter element that removes particulate contaminants from a fluid passing through the filter element. Additionally, the media pack directs the flow of fluid through the filtration sheet via the support layer. The term “media form” refers to a joined layering of materials (e.g., sheets of media or structural materials) that may be folded, stacked, or otherwise altered into a desired shape to form the media pack. Finally, the term “filter media” may be used to describe, generally, one or more of the media pack and/or media form throughout the description.

### II. Example Filter Elements

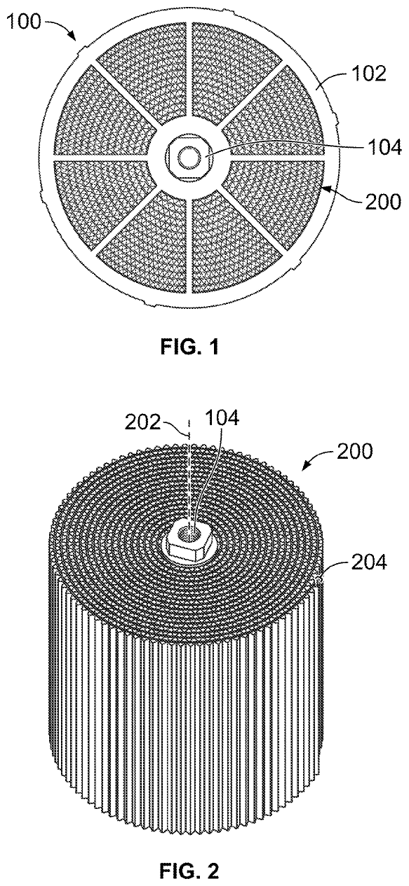

FIG. 1 is a top view of a filter element 100, according to an example embodiment. The filter element 100 may be replaceable a lube oil filter cartridge for an internal combustion engine system. In other embodiments, the filter element 100 may be a replaceable cartridge for a fuel filter or another fluid (e.g., liquid, air, etc.) filtration system. As shown in FIG. 1, the filter element 100 includes an endcap 102, a center tube 104, and a media pack 200. In some embodiments, the filter element 100 may form part of a filter assembly that includes a housing (not shown) and/or other components to engage the filter element 100 with the filtration system and to prevent leakage from the filtration system.

The endcap 102 is coupled to and supports the center tube 104 and the media pack 200. In some embodiments, the endcap 102 includes an O-ring or another sealing element to prevent fluid from bypassing the media pack 200 along the interface between the endcap 102 and the housing and/or other parts of the filter assembly. As shown in FIG. 1, the endcap 102 is disposed on an axial end (e.g., upper end, upstream end, downstream end, etc.) of the media pack 200. The endcap 102 includes a plurality of openings [[106]] configured to fluidly couple the axial end of the media pack to other parts of the filtration system. The filter element 100 also includes a ring of adhesive material (e.g., epoxy, glue, etc.) that extends around an outer perimeter of the media pack 200 and prevents fluid from bypassing the media pack 200 through the interface between the media pack 200 and the endcap 102.

Referring to FIG. 2, the media pack 200 of the filter element 100 is shown. The media pack 200 is coupled to and supported by the center tube 104, which extends along a central axis 202 of the media pack 200. Specifically, the media pack 200 is spiral wound around the center tube 104 such that the media pack 200 circumferentially surrounds the center tube 104. The media pack 200 is sealingly engaged with the center tube 104 to prevent fluid bypass through the cylindrical volume formed by the inner layers of the media pack 200.

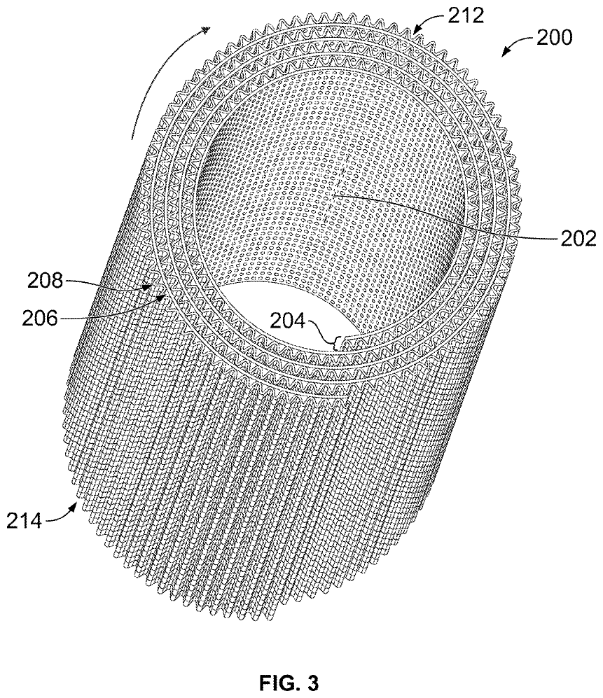

As shown in FIG. 2, the media pack 200 may be formed by a coiled media form, shown as media form 204 that is spiral wound around the center tube 104. Referring to FIG. 3, a portion of the media form 204 from the media pack 200 of FIGS. 1-2 is shown. The media form 204 includes a plurality of media layers (e.g., sheets, etc.) that are wound on top of one another in a radial direction (e.g., substantially normal to the central axis 202 of the media pack 200). The media pack 200 is formed by winding the media form 204 together in a spiral shape/configuration, resulting in a media pack 200 that is substantially cylindrical in shape. In other embodiments, the layers may be wound in an oblong shape (e.g., an elongated rectangle/racetrack or oval shape), a square shape, a rectangular shape, or another suitable shape.

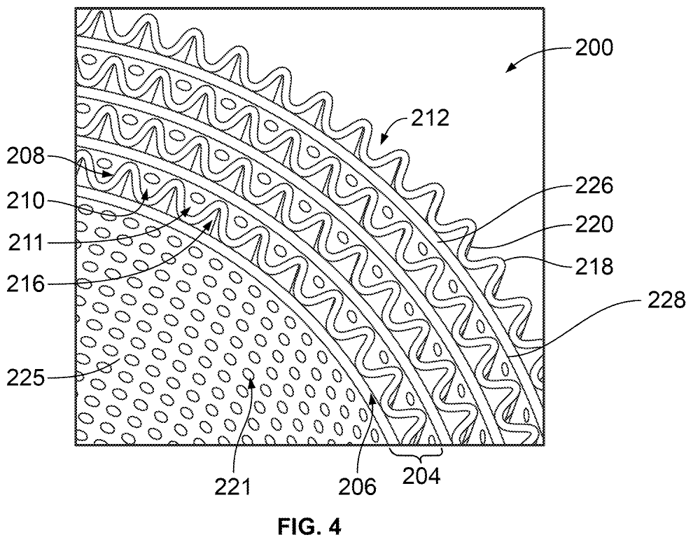

FIG. 4 shows an axial end portion of the media form 204. As shown, the media form 204 includes a filtration sheet 206 and a support sheet 208 (which may be, for example, a second filtration sheet) stacked on top of one another in alternating fashion. In the embodiment of FIG. 4, the support sheet 208 is corrugated (e.g., pleated, folded, etc.) sheet, while the filtration sheet 206 is a substantially flat (e.g., planar, uncorrugated, etc.) sheet that extends between the support sheets. Together, the filtration sheet 206 and the support sheet 208 form a plurality of axial flow channels, shown as channels 210 that are arranged in a substantially parallel orientation relative to the central axis 202. The channels 210 are alternately sealed at each end of the media pack 200 such that an open channel at a first axial end 212 of the media pack 200 is closed at a second axial end 214 of the media pack 200 opposing the first axial end 212.

In the embodiment shown in FIG. 4, the channels 210 are formed by the filtration sheet 206 and the corrugations in the support sheet 208. The channels 210 extend along an entire axial length of the media pack 200 and are coextensive with one another along the axial direction. In other embodiments, the channels 210 may only extend along a portion of the axial length of the media pack 200 (e.g., from a first end of the media pack 200 to an intermediate axial position along the media pack 200). Moreover, in some embodiments, the channels 210 may be only partially coextensive with one another (e.g., may overlap along only an axial portion of the channels 210), or may not overlap one another at all in the axial direction. For example, the channels 210 may be structured to direct the flow toward an intermediate axial position along the media pack 200. Additionally, a cross-sectional shape of a first set of channels 210 (e.g., inlet channels, outlet channels, etc.) may be different from a second set of channels 210, as will be further described. The cross-sectional shape of the channels 210 may also vary along the axial direction, parallel to the central axis of the media pack 200.

In the embodiment of FIG. 4, the channels 210 are alternatively sealed on opposing axial ends of the media pack 200. A first plurality of channels 211 are defined by an outer surface (e.g., radially outer) of each support sheet 208. The first plurality of channels 211 are open at the first axial end 212 and are closed off (e.g., sealed, etc.) at the second axial end 214 (see FIG. 3). In contrast, a second plurality of channels 216 (defined by an inner surface of each support sheet 208) are closed off at the first axial end 212 and open at the second axial end 214 (see FIG. 3). In other embodiments, such as where the channels 210 only extend along a portion of the axial length of the media pack 200, one end of the channels 210 may be closed off by and/or terminate at the filtration sheet 206 and/or support sheet 208. In the embodiment of FIG. 4, the channels 210 may be closed off at either axial end using hotmelt, glue, or another suitable adhesive product during the manufacturing process. In other embodiments, the ends of the channels 210 can be closed off without glue or adhesive. For example, the ends of the channels 210 can be closed off by folding a preformed support sheet over the end of the filtration sheet 206.

In operation, dirty fluid entering the media pack 200 of FIGS. 3-4 through the second axial end 214 passes axially (substantially parallel to the central axis 202) through the first plurality of channels 211 (e.g., the channels defined by an outer radial surface of the support sheet 208), in a direction that is substantially parallel to the walls of the first plurality of channels 211. The fluid passes through the walls of the filtration sheet 206, from a dirty side of the filtration sheet 206 to an adjacent one of the second plurality of channels 216 on a clean side of the filtration sheet 206 (e.g., the channels defined by an inner radial surface of the support sheet 208), where the fluid is discharged from the media pack 200. The fluid may also pass through the walls of the support sheet 208, in a direction opposite the filtration sheet 206. The forces exerted by the fluid on the filtration sheet 206 is therefore at least partially balanced by the forces exerted by the fluid in an opposite direction through the support sheet 208, which reduces the accumulation (e.g., buildup, etc.) of radial force toward the central axis 202 of the media pack 200.

In the embodiment of FIG. 4, the support sheet 208 is pleated (e.g., doubled back on itself), folded, or otherwise formed into a “U” shape or “V” shape defining channels having a substantially triangular cross-sectional shape. In other embodiments, the support sheet 208 may be formed into another suitable shape. For example, the support sheet 208 may be pleated, folded, or otherwise formed into a continuous sine wave shape, a sawtooth shape, or another suitable shape. Similarly, the cross-sectional shape of the channels 210 may differ in various embodiments. For example, the support sheet 208 and the filtration sheet 206 may define channels having an elliptical cross-sectional shape, a rectangular cross-sectional shape, or another suitable shape. Depending on the cross-sectional geometry of the channels 210, the media pack 200 may include elliptical channels, rectangular channels, or another suitable shape. As described above, in some embodiments the shape of the corrugations varies in the flow direction (e.g., axially) along the media pack 200 such that the channels having a non-uniform geometry along a flow direction (e.g., axial direction, parallel to the central axis, etc.) through the media pack 200. For example, the support sheet 208 may be bent or otherwise formed such that size of the channels varies along the flow direction through the media pack 200.

The geometry of the support sheet 208 can be varied depending on the desired performance of the filter element (e.g., the desired media area, the structural stiffness, etc.), including a bend angle between adjacent corrugations (formed at the apex of a single corrugation), a width of the corrugations, a height of the corrugations and/or change in the height along the axial direction, a length of the corrugations in the axial direction (e.g., a length of the channels), pleat tip radius, and/or other geometric parameters of the support sheet 208.

The support sheet 208 provides structural support to the media pack 200 (e.g., the filtration sheet 206), directs fluid along the channels 210 toward and away from the filtration sheet 206, and prevents deformation and/or collapse of the channels 210 under an applied fluid pressure drop across the media pack 200. As shown in FIG. 4, the support sheet 208 includes a media sheet 218 and a perforated sheet 220 that is engaged with the media sheet 218. Both the media sheet 218 and the perforated sheet 220 are corrugated such that a shape of the perforated sheet 220 substantially corresponds with a shape of the media sheet 218. In the embodiment of FIG. 4, the perforated sheet 220 is disposed on an outer radial surface of the media sheet 218. In other embodiments, the perforated sheet 220 is disposed on an inner radial surface of the media sheet 218. The perforated sheet 220 provides structural support to the media sheet 218 and substantially prevents the media sheet 218 from deforming under an applied fluid pressure across the support sheet 208. The perforated sheet 220 includes a plurality of openings 221 (e.g., perforations, holes, slots, etc.) that allow fluid to pass therethrough. The perforated sheet 220 may include a perforated metallic sheet (e.g., aluminum), a wire mesh, a wire screen, a perforated plastic sheet (e.g., nylon, phenolic, etc.), and/or another perforated material.

The media sheet 218 of the support sheet 208 includes a filter media including a porous material having a mean pore size that is configured to filter particulate matter from a fluid flowing therethrough so as to produce a filtered fluid. The media sheet 218 may include any suitable fibrous filter media, membrane filter media, and/or composite filter media with particle removal and restriction characteristics appropriate to the application. Notably, the structure provided by support sheet 208 allows for the use of nanofiber material (e.g., a material including fibers with a fiber diameter less than or equal to approximately 1 μm), which is normally prohibited due to the susceptibility of nanofiber to deformation under an applied fluid pressure. The media sheet 218 may additionally include one or more reinforcement layers (e.g., sheets, etc.) such as a scrim layer to support the nanofiber material. For example, the media sheet 218 may include two scrim layers with nanofiber sandwiched or otherwise disposed in between the scrim layers. In some embodiments, the media sheet 218 includes fibers or nanofiber of a polymer such as polyamide, nylon, polyester, fluorocarbon, glass, ceramic, metal, and/or other materials. Various examples of nanofiber materials suitable for use in liquid filtration are provided in U.S. Pat. No. 8,678,202, filed May 2, 2013, U.S. Patent Publication No. 2018/0243675, filed Apr. 27, 2018, U.S. Pat. No. 10,391,434, filed Jul. 3, 2018, U.S. Patent Publication No. 2019/0160405, filed Oct. 8, 2018, and U.S. Pat. No. 9,199,185, filed May 14, 2010, all of which are hereby incorporated by reference herein.

The mechanical strength provided by the support sheet 208 also allows for a reduction in the material thickness of the media sheet 218 as compared to other axial flow filter element design configurations. Among other benefits, the use of a thinner media sheet allows greater filter media surface area to be packaged within a given volume, which results in an approximately corresponding increase in filter life.

The filtration sheet 206 is a substantially flat, unpleated media layer that is “sandwiched” or otherwise disposed in between adjacent layers of the support sheet 208. As shown in FIG. 4, the filtration sheet 206 also includes a perforated sheet, shown as second perforated sheet 225 and a media sheet, shown as second media sheet 226. In other embodiments, the filtration sheet 206 may only include the second media sheet 226 (without the second perforated sheet 225). The second media sheet 226 may be similar to or substantially the same as the media sheet 218. In other embodiments, the second media sheet 226 may have a different pore size, permeability (to the fluid to be filtered), and/or material composition. The second perforated sheet 225 may be bonded or otherwise coupled to the second media sheet 226, and/or may be simply engaged with the second media sheet 226. In the embodiment of FIG. 4, the second perforated sheet 225 is bonded to an inner radial surface 228 of the second media sheet 226, facing the first perforated sheet of the support sheet. Among other benefits, this arrangement allows a single layer of adhesive to be used to bond together each layer of the filtration sheet 206 and the support sheet 208 (e.g., a single layer of adhesive to bond together each of the first perforated sheet, the first media sheet, the second perforated sheet 225, and the second media sheet 226). In other embodiments, the second perforated sheet 225 may be bonded to an outer radial surface of the second media sheet 226. The second perforated sheet 225 may include similar materials as the perforated sheet 220, or may include different materials than the perforated sheet 220.

In the embodiment of FIG. 4, a single layered combination of the filtration sheet 206 and the support sheet 208 define the media form 204 for the media pack 200, and are wound in a spiral shape to form the media pack 200. Among other benefits, incorporating a perforated backing (e.g., perforated sheet 220) into the support sheet 208 eliminates the need for glue and/or other bonding/adhesive materials to retain the corrugated form of the support sheet 208 (e.g., eliminates the need to bond the support sheet 208 to the filtration sheet 206). The perforated backing also increases the overall structural integrity of the media pack 200 at increased fluid pressures and temperatures. Among other benefits, the incorporation of the perforated sheet 220 into the support sheet 208 improves the overall media area by approximately 50%-200% as compared to existing designs, thereby improving the overall service life of the filter element of a given volume. The construction also provides an approximately linear relationship between the pressure drop across the media pack 200 and the fluid flow rate through the media pack 200. An overall axial height of the media pack 200 can also be easily varied to accommodate higher fluid flow rates through the media pack 200, without sacrificing the media area of the media pack 200 (i.e., without requiring substantially greater media area to compensate for the increase in differential fluid pressure across the media pack 200).

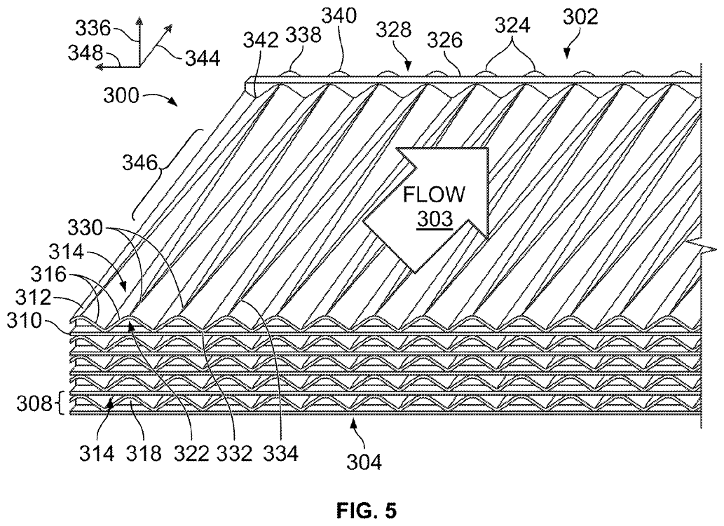

The arrangement and geometry of the media pack 200 described with reference to FIGS. 1-4 should not be considered limiting. Many variations are possible without departing from the inventive concepts disclosed herein. For example, FIG. 5 shows a perspective views of a media pack 300 (e.g., uncoiled media pack) that includes a support sheet 308 having a different geometry from the media pack 200 of FIGS. 1-4. As shown in FIG. 5, the support sheet 308 is defined by a plurality of interdigitated tetrahedral forms extending from the opposing ends of the media pack 300.

As shown in FIG. 5, the wall segments include a first set of wall segments 316 alternately sealed to each other at the upstream end 304, e.g. by adhesive 318 or the like, to define a first set of forms 314 (e.g., tetrahedron forms, etc.) having open upstream ends, and a second set of forms 322 interdigitated with the first set of forms 314 and having closed upstream ends. The wall segments also include a second set of wall segments 324 alternately sealed to each other at the downstream end 302, e.g., by adhesive 326 or the like, to define a third set of forms (not shown—similar in geometry to the second set of forms 322) having closed upstream inlets, and a fourth set of forms 328 interdigitated with the third set of forms and having open upstream inlets. A first set of bend lines 330 includes a first subset of bend lines 332 defining the first set of forms 314, and a second subset of bend lines 334 defining the second set of forms 322. The second subset of bend lines 334 taper in transverse direction 336 as they extend from the upstream end 304 axially towards the downstream end 302. A second set of bend lines 338 includes a third subset of bend lines 340 defining the third set of forms, and a fourth subset of bend lines 342 defining the fourth set of forms 328. The third subset of bend lines 340 taper in the transverse direction 336 as they extend from the upstream end 304 axially towards the downstream end 302. The second set of forms 322 have a decreasing transverse height along transverse direction 336 as the second set of forms 322 extend axially along axial direction 344 towards the downstream end 302. The tapering of the second subset of bend lines 334 in the transverse direction 336 provides the decreasing transverse height of the second set of forms 322. The third set of forms have a decreasing transverse height along transverse direction 336 as the third set of forms extend axially along axial direction 344 towards the upstream end 304. The tapering of the third subset of bend lines 340 in the transverse direction 336 provides the decreasing transverse height of the third set of forms.

Incoming dirty fluid to be filtered flows along axial direction 344 into open ones of the first set of forms 314 at the upstream end 304 and passes transversely through the filtration sheets 310 and then flows axially along axial direction 344 as clean filtered fluid through open forms (e.g., the third set of forms) at the downstream end 302. In some embodiments, the flow 303 is reversed through the media pack 300 such that incoming dirty fluid to be filtered flows along axial direction 344 into open forms (e.g., the third set of forms) and passes transversely through the filtration sheets 310 and then flows axially along axial direction 344 as clean filtered fluid through open ones of the first set of forms 314.

The second subset of bend lines 334 taper to respective termination points, providing at such termination points the minimum transverse height of the second set of forms 322. The third subset of bend lines 340 taper to respective termination points providing at such termination points the minimum transverse height of the third set of forms. Termination points of the second subset of bend lines 334 are axially downstream of termination points of third subset of bend lines 340. This arrangement provides a common volume 346 within which flow can distribute in multiple directions between opposing ends of the media pack 300.

The first set of wall segments 316 are alternately sealed to each other at adhesive 318 at the upstream end 304 define a first set of forms 314 having open upstream ends, and a second set of forms 322 interdigitated with the first set of forms 314 and having closed upstream ends. The second set of wall segments 324 are alternately sealed to each other at adhesive 326 at the downstream end 302 to define a third set of forms having closed upstream inlets, and a fourth set of forms 328 interdigitated with the third set of forms and having open upstream inlets.

The first set of forms 314 and the second set of forms 322 face oppositely to the third set of forms and the fourth set of forms 328. Each of the forms is elongated in the axial direction 344. Each of the forms has a cross-sectional area along a cross-sectional plane defined by the transverse direction 336 and the lateral direction 348. The cross-sectional areas of the first set of forms 314 and the second set of forms 322 decrease as the first set of forms 314 and the second set of forms 322 extend along axial direction 344 from the upstream end 304 toward the downstream end 302. The cross-sectional areas of third set of forms and the fourth set of forms 328 decrease as the third set of forms and the fourth set of forms 328 extend along axial direction 344 from the downstream end 302 toward the upstream end 304. The bend lines in the support sheet 312 may be bent at a sharp pointed angle or rounded along a given radius, as shown in FIG. 5. In other embodiments, another suitable geometry may be formed into the support sheet 312.

Referring to FIGS. 2-3, the media pack 200 is formed by winding, rolling, and/or wrapping the media form 204 in a spiral around a mandrel (e.g., the center tube 104 of FIG. 1). More specifically, a method of making the media pack 200 includes providing a support sheet 208, including a perforated sheet 220 and a media sheet 218, and providing a filtration sheet 206, including a second perforated sheet 225 and a second media sheet 226. Each individual sheet (the perforated sheet 220, media sheet 218, second perforated sheet 225, and second media sheet 226) may be provided as bulk material rolls cut to an approximately equal width. The method may include engaging the perforated sheet 220 with the media sheet 218 and pleating, folding, bending, or otherwise forming corrugations into the layer formed by the perforated sheet 220 and the media sheet 218 (e.g., to form the support sheet 208). With respect to the filtration sheet 206, the method may further include bonding the second perforated sheet 225 to the second media sheet 226, for example, by applying an adhesive material to the second perforated sheet 225 and engaging the second perforated sheet 225 with the second media sheet 226. In some embodiments, the support sheet 208 may also include an adhesive material to bond the perforated sheet 220 to the media sheet 218.

As shown in FIG. 3, the method additionally includes engaging the filtration sheet 206 with the support sheet 208 into a media form 204. The method may include bonding a first end of the filtration sheet 206 to the support sheet 208. For example, the method may include aligning the filtration sheet 206 with the support sheet 208 at a position above the support sheet 208, and applying adhesive material (e.g., glue, hotmelt, etc.) to seal the first ends of the media form 204 (e.g., along one of the upstream or downstream ends of the support sheet 208, in between corrugations, etc.). Alternatively, the adhesive may be applied to the first end of the filtration sheet 206, or to the first end of both the support sheet 208 and the filtration sheet 206. Next, the filtration sheet 206 is applied to an upper surface of the support sheet 208 onto the adhesive. The method further includes applying a second bead of adhesive to the filtration sheet 206, parallel to the first bead, along an opposing end (e.g., second end) of the filtration sheet 206 as the first bead. Together, the support sheet 208, the filtration sheet 206, and the first and second adhesive beads form the media form 204. The method additionally includes winding the media form onto itself along a feed direction parallel to the first and second adhesive beads (e.g., in a clockwise rotation as shown in FIG. 3). In other embodiments, the method may include additional, fewer, and/or different operations.

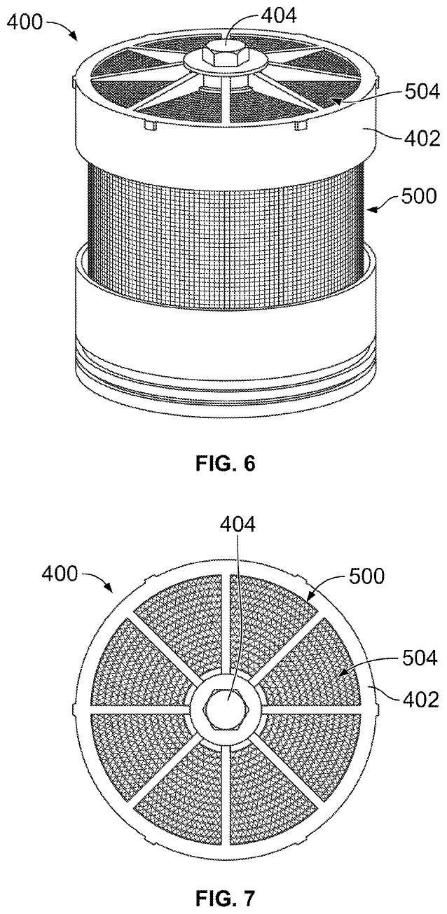

The design of the media pack 200 may differ in various example embodiments. Referring now to FIGS. 6-7, a filter element 400 is shown that includes a modified support sheet structure, according to an example embodiment. Similar to the embodiment in FIGS. 1-4, the filter element 400 of FIGS. 6-7 includes a media pack 500 including a media form 504 that is spiral wound around a center tube 404. The filter element 400 also includes endcaps 402 coupled to the media pack 500 on opposing axial ends of the media pack 500 that directs the fluid flow into and out of the media pack 500.

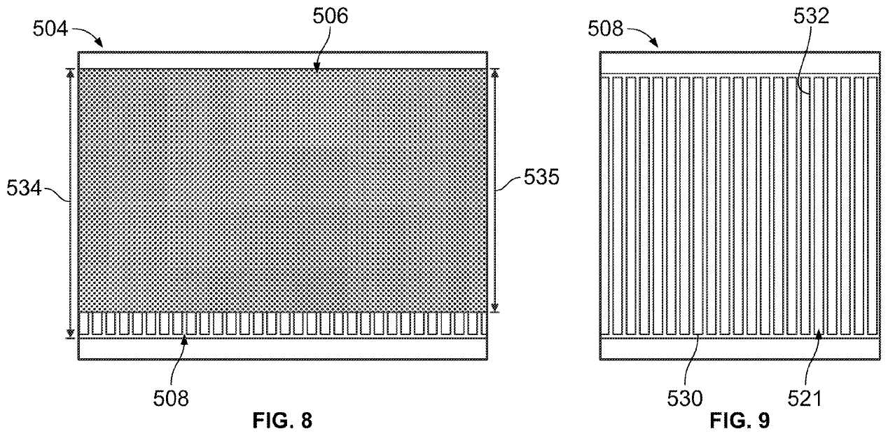

Referring to FIG. 8, a front view of the media form 504 for the media pack 500 is shown, according to an example embodiment. The media form 504 includes a filtration sheet 506 and a support sheet 508 (which may be, for example, a spacer sheet, a spacer layer, etc.) that is engaged with the filtration sheet 506. The filtration sheet 506 may be similar to or substantially the same as the filtration sheet 206 described with reference to FIG. 4. The support sheet 508 acts as a spacer sheet in between adjacent layers of the filtration sheet 506 in the media pack 500, to direct flow toward or away from the filtration sheets 506 on either side of the support sheet 508.

As shown in FIGS. 7-8, the support sheet 508 is “sandwiched” or otherwise disposed between adjacent layers of the filtration sheet 506. As shown in FIG. 9, the support sheet 508 includes a body 530 having extending members 532 (e.g., legs, beams, axial extensions, etc.) that together define a plurality of openings 521 (e.g., slots, through-hole openings, etc.). The extending members 532 are spaced at approximately equal intervals along the length of the support sheet 508 (e.g., along a winding direction for the media pack). In other embodiments, the size, position, and/or spacing between adjacent extending members 532 may be different. As shown in FIGS. 8-9, the openings 521 are arranged parallel or substantially parallel to one another and extend in an axial direction that is substantially parallel to a central axis of the media pack 500. The openings 521 define a plurality of axial flow channels that extend along an entire axial length of the media pack 500 and that direct fluid into and out of the media pack 500 (see also FIG. 7). The body 530 may be made from a metal (e.g., aluminum, etc.), plastic (e.g., nylon, etc.), or another suitable material.

In the example embodiment of FIGS. 8-9, the axial ends of the body 530 (i.e., each axial end of the openings 521) are blocked off (e.g., closed, etc.) by the body 530. Among other benefits, closing the ends of the body 530 increases the structural integrity of the support sheet 508 and the media pack 500. In such implementations, an axial length 534 of the support sheet 508 is greater than an axial length 535 of the filtration sheet 506. In this way, the fluid may enter or exit the media pack 500 through exposed axial end portions of the openings 521. Alternating axial ends of the support sheet 508 may be closed off using an adhesive material (e.g., glue, epoxy, etc.) during manufacturing (e.g., during the winding operation) to form the respective inlet and outlet channels through the support sheet 508. In other embodiments, a first axial end of the openings 521 (e.g., a closed end) may be substantially aligned with the edge of the filtration sheet 506 (e.g., in-line with the media height), while a second axial end of the openings 521 (e.g., open end) protrudes beyond the filtration sheet 506 and is open to the fluid flow. A second support sheet (that is the same as support sheet 508) is then applied in reverse orientation on the other side of the filtration sheet to ensure that alternating axial ends of the support sheet are open in adjacent layers.

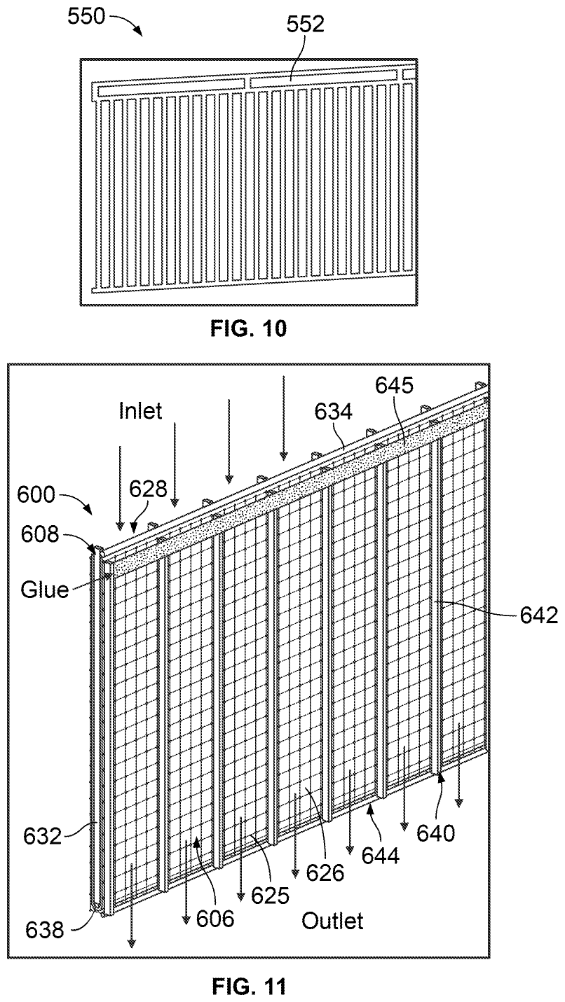

In some embodiments, the support sheet may include a glue slot to help connect the adjacent layers together (e.g., all five layers including the support sheet and two adjacent filtration sheets, each including a perforated sheet and filter media layer). For example, FIG. 10 shows a support sheet 550 that includes a plurality of slots 552 extending in a lateral direction (e.g., substantially perpendicular to the extending members and openings, substantially parallel to a roll direction for the support sheet 550 (tangential direction), etc.). The slots 552 are disposed on a first (e.g., upper) end of the support sheet 550 and together extend along an entire length of the support sheet 550. The slots 552 are sized to receive an adhesive material (e.g., glue, etc.). In at least one embodiment, the slots 552 are elongated rectangular openings. In other embodiments, the shape and/or size of the slots 552 may be different. During manufacturing, the adhesive material is placed into the slots 552, and the filtration sheets are applied over the slots 552 to at least partially cover the slots 552, and to bond the filtration sheets on either side to the support sheet 550. Among other benefits, the slots 552 in the support sheet 550 helps contain the adhesive product during manufacturing and provides a single connection point between the filtration sheets on either side of the support sheet 550. The slots 552 can be positioned at the inlet of the media pack, the outlet of the media pack, or both depending on whether the filtration sheet is wrapped around the support sheet 550 or not.

Alternatively, the body 530 may designed such that only one axial end of the openings 521 are open (e.g., unenclosed) and the other axial end of the openings 521 are closed (e.g., plugged, etc.), and may be applied in reversed orientations on either side of the filtration sheet 506. The body 530 at the closed ends of the openings 521 may be used as a support and may be bonded or otherwise coupled to the filtration sheets 506 on either side of the support sheet 508.

The design of the media form may differ in various example embodiments. Referring to FIG. 11, a media form 600 that includes a folded filtration sheet is shown, according to an example embodiment. The filtration sheet 606 again includes a perforated sheet 625 and a media sheet 626 that is engaged with the perforated sheet 625. The perforated sheet 625 may be bonded to the media sheet 626 using an adhesive material or otherwise coupled to the media sheet 626. In some embodiments, the filtration sheet 606 only includes the media sheet 626, for example, in implementations where the media sheet 626 is made from a cellulose material or another sufficiently strong material.

As shown in FIG. 11, the support sheet 608 may be similar to or substantially the same as the support sheet 508 described with reference to FIGS. 8-9. In the embodiment of FIG. 11, the support sheet 608 includes a plurality of extending members 632 (e.g., legs, beams, axial extensions, etc.) arranged substantially parallel to one another and spaced in approximately equal intervals along a winding direction of the media form 600 (e.g., in a direction that is substantially perpendicular to the central axis of the media block). The gaps between adjacent extending members 632 define a first plurality of channels 628 (e.g., axially extending channels, etc.) to direct fluid toward or away from the filtration sheet 606. The support sheet 608 also includes end connectors 634 (e.g., strips, etc.) disposed on opposing axial ends of the extending members 632 and coupling the extending members 632 together. As shown in FIG. 11, the end connectors 634 are oriented perpendicular or substantially perpendicular to the extending members 632. In at least one embodiment, the end connector 634 on at least one axial end of the extending members 632 includes a piece of wire or plastic having a substantially cylindrical shape. The end connectors 634 may be made from the same material as the extending members 632 or a different material that is coupled to the extending members 632. As shown in FIG. 11, the end connectors 634 are offset from a central axis of each of the extending members 632 (e.g., are disposed proximate to an outer lateral edge/side of the extending members 632), which, advantageously, reduces the flow restriction (e.g., pressure drop) across the axial end of the support sheet 608. In other embodiments, at least one of the end connectors 634 is coupled to an axial end of the extending members 632 at an approximately central position along the axial end.

The filtration sheet 606 is approximately twice the axial height of the support sheet 608 and is wrapped around an axial end 638 of the support sheet 608 such that the filtration sheet 606 (e.g., media, etc.) substantially covers three sides of the support sheet 608. In this way, the filtration sheet 606 closes off the first plurality of channels 628. Among other benefits, folding the filtration sheet 606 over the axial end 638 of the support sheet 608 eliminates the need to apply an adhesive material to both axial ends (e.g., the lower end as shown in FIG. 11) of the media form 600. As shown in FIG. 11, the media sheet 626 is disposed between the perforated sheet 625 and the support sheet 608. The media form 600 also includes a second support sheet 640 that is engaged with the perforated sheet 625. The second support sheet 640 may be similar to or substantially the same as the support sheet 608. As shown in FIG. 11, the extending members 632 of the support sheet 608 are substantially aligned with a second set of extending members 642 of the second support sheet 640 such that the first plurality of channels 628 is substantially aligned (e.g., radially aligned) with a second plurality of channels 644 formed by the second set of extending members 642. An adhesive material 645 (e.g., glue, epoxy, etc.) is applied to an upper axial end of the second support sheet 640 to close off (e.g., plug, etc.) the upper axial end of the second plurality of channels 644 and prevent the flow of fluid through the upper axial end. Among other benefits, the openings (e.g., slots) formed at the upper axial end of the second support sheet 640 in combination with the end connector 634 simplifies the application of adhesive material to the second support sheet 640.

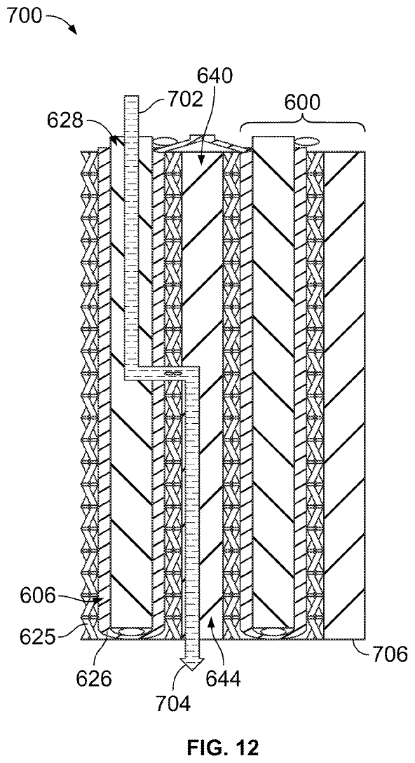

Referring now to FIG. 12, a side cross-sectional view of a media pack 700 made from the media form 600 of FIG. 11 is shown, according to an example embodiment. Incoming dirty fluid 702 enters the media pack 700 through the first plurality of channels 628 (e.g., inlet channels) and flows in a substantially axial direction toward the folded end of the filtration sheet 606. The flow may also pass radially (e.g., left or right as shown in FIG. 12) through the filtration sheet 606 along an axial length of the filtration sheet 606 (e.g., through the media sheet 626 and the perforated sheet 625) and into the second plurality of channels 644 as clean fluid 704. The clean fluid 704 is directed by the second plurality of channels 644 (e.g., the second support sheet 640) toward a lower axial end of the media pack 700, where it is ejected through axial end openings 706. In another embodiment, the direction of fluid flow through the media pack 700 may be reversed.

Among other benefits, the design of the media form 600 reduces the quantity of adhesive materials needed to produce the media pack, and the manufacturing complexity, while maintaining structural integrity of the media pack. The perforated sheet 625 in combination with the support sheet 608 increases the overall structural stability of the media sheet 626. The design of the media form 600 also improves the media area by approximately 100% and 150% compared to existing designs.

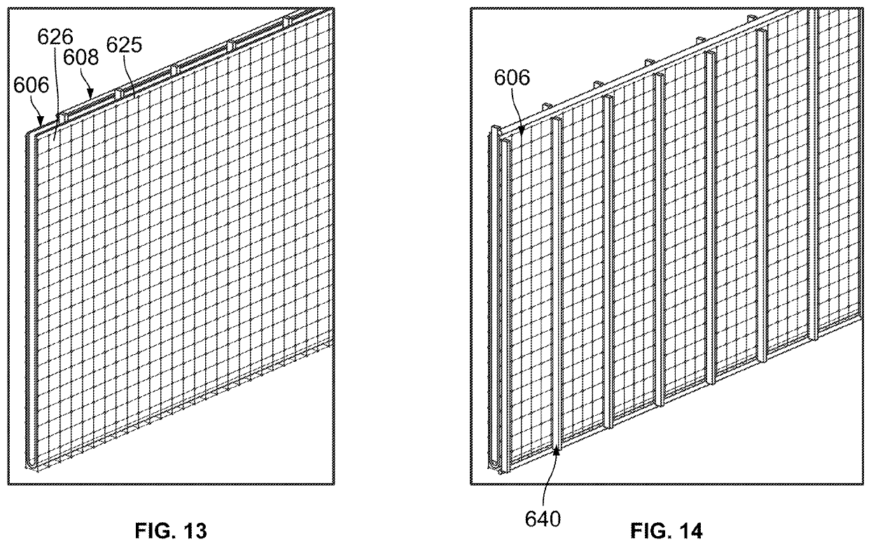

Referring to FIGS. 13-16, a method of making the media pack 700 of FIG. 12 is shown, according to an example embodiment. As shown in FIG. 13, the method includes providing a filtration sheet 606 and a support sheet 608 and wrapping the filtration sheet 606 around one axial end of the support sheet 608. Providing the filtration sheet 606 may include providing a media sheet 626 (e.g., in the form of a bulk roll, etc.), cutting the media sheet 626 to the desired axial length (e.g., to approximately twice the axial height of the support sheet 608), and coupling the perforated sheet 625 to the media sheet 626. The method may further include applying an adhesive material to the perforated sheet 625 before engaging the perforated sheet 625 with the media sheet 626.

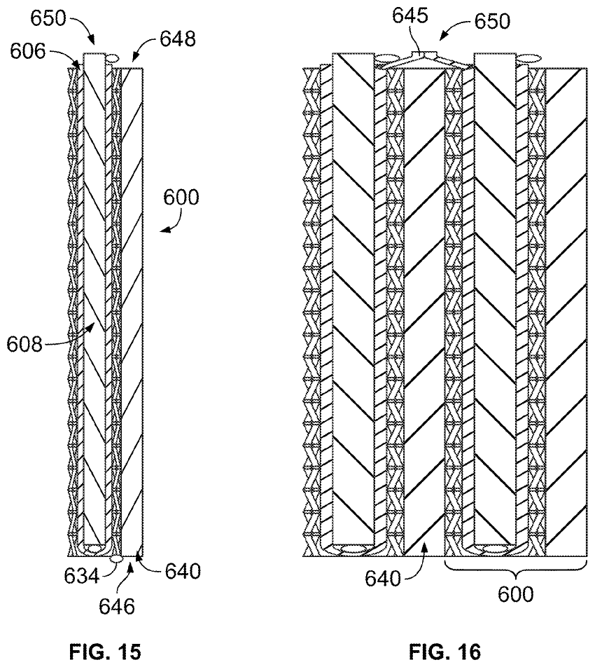

As shown in FIG. 14, the method includes providing a second support sheet 640 and engaging the second support sheet 640 with the filtration sheet 606. As shown in FIG. 15, engaging the second support sheet 640 with the filtration sheet 606 may include aligning a lower axial end 646 of the second support sheet 640 with the folded end of the filtration sheet 606, such that a surface at the lower axial end 646 of the second support sheet 640 is substantially flush with an outer surface at the folded end of the filtration sheet 606 (e.g., so that an end connector 634 at the lower axial end 646 engages the folded end of the filtration sheet 606, so that an upper axial end 648 of the second support sheet 640 is offset from an upper axial end 650 of the support sheet 608, etc.). As shown in FIG. 16, the method additionally includes applying an adhesive material 645 to the upper axial end 648 of the second support sheet 640, in a line across the second support sheet 640 and winding, rolling, and/or wrapping the media form 600 in a spiral around a mandrel.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given angle or other value) are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A media pack, comprising:
a filtration sheet; and
a support sheet engaged with the filtration sheet, the support sheet comprising a first perforated sheet and a first media sheet, the first perforated sheet and the first media sheet being corrugated, the filtration sheet and the support sheet wound together in a substantially spiral shape and forming a plurality of channels, the channels alternatively sealed on opposing ends of the media pack.

2. The media pack of claim 1, wherein the filtration sheet comprises a second perforated sheet and a second media sheet.

3. The media pack of claim 2, wherein the channels are alternatively sealed by a single layer of adhesive that bonds together each of the first perforated sheet, the first media sheet, the second perforated sheet, and the second media sheet.

4. The media pack of claim 2, wherein the second perforated sheet is bonded to the second media sheet.

5. The media pack of claim 1, wherein the first perforated sheet comprises a wire screen.

6. The media pack of claim 1, wherein the support sheet is not bonded to the filtration sheet.

7. The media pack of claim 1, wherein the channels are alternatively sealed by a single layer of adhesive that bonds the first perforated sheet and the first media sheet to the filtration sheet.

8. The media pack of claim 1, wherein a shape of the first perforated sheet matches a shape of the first media sheet.

9. The media pack of claim 1, wherein the first media sheet comprises a nanofiber material.

10. A media pack, comprising:
a first support sheet;
a second support sheet, the first support sheet and the second support sheet each comprising a plurality of openings extending along a central axis of the media pack; and
a media sheet disposed between and engaged with the first support sheet and the second support sheet.

11. The media pack of claim 10, wherein a first end of the media sheet is bonded to the first support sheet, and a second end of the media sheet opposite the first end is bonded to the second support sheet.

12. The media pack of claim 10, wherein the media sheet is wrapped around an end of the first support sheet such that the media sheet substantially covers three sides of the first support sheet.

13. The media pack of claim 12, wherein the media sheet is only bonded to the first support sheet or second support sheet at a first end of the media sheet.

14. The media pack of claim 10, wherein the first support sheet, the media sheet, and the second support sheet are wound together in a substantially spiral shape, the first support sheet and the second support sheet forming a plurality of channels that are alternatively sealed on opposing ends of the media pack.

15. The media pack of claim 10, further comprising a perforated sheet bonded to the media sheet.

16. The media pack of claim 10, wherein the media sheet comprises a first filtration sheet that includes the media sheet and a first perforated sheet, and further comprising a second filtration sheet disposed on a second side of the second support sheet as the first filtration sheet, the second filtration sheet including a second media sheet and a second perforated sheet.

17. The media pack of claim 16, wherein the second support sheet includes a transverse slot and an adhesive material disposed within the transverse slot, wherein the adhesive material bonds together each of the media sheet, the first perforated sheet, the second media sheet, the second perforated sheet, and the second support sheet.

18. The media pack of claim 10, wherein an axial length of at least one of the first support sheet or the second support sheet is greater than an axial length of the media sheet.

19. A support sheet for a media pack, comprising:
a plurality of extending members spaced apart from one another to define a plurality of axially extending channels;
a first end connector coupled to a first end of the plurality of extending members and extending substantially perpendicular to the plurality of extending members, the first end connector offset from a central axis of at least one of the plurality of extending members; and
a second end connector extending substantially parallel to the first end connector and coupled to a second end of the plurality of extending members opposite the first end.

20. The support sheet of claim 19, wherein the plurality of extending members are spaced apart from one another at approximately equal intervals.

21. The support sheet of claim 19, wherein the first end connector has a substantially cylindrical shape.

22. The support sheet of claim 19, wherein the second end connector is coupled to the second end of the plurality of extending members at a central position along the second end.
